(19) United States
(12) Patent Application Publication
(10) Pub. No.: US 2026/0261725 A1
(43) Pub. Date: Sep. 3, 2026

(54) STREAMING HIGH DYNAMIC RANGE AND WIDE COLOR GAMUT VIDEO CONTENT

(71) Applicant: DOLBY LABORATORIES LICENSING CORPORATION, San Francisco, CA (US)

(72) Inventors: Qi Huang, Beijing (CN); Baoli Yan, Beijing (CN)

(73) Assignee: DOLBY LABORATORIES LICENSING CORPORATION, San Francisco, CA (US)

(21) Appl. No.: 19/552,178

(22) Filed: Feb. 27, 2026

(30) Foreign Application Priority Data
Feb. 28, 2025 (WO) PCT/CN2025/079730

(51) Int. Cl. H04N 21/2662; H04N 21/234; H04N 21/239; H04N 21/442

(52) U.S. Cl. CPC H04N 21/2662; H04N 21/234; H04N 21/2393; H04N 21/44209

(57) ABSTRACT

Systems and methods for streaming HDR/WCG video content. An example method includes receiving from a client device a request identifying HDR/WCG video content to be streamed. The method also includes generating a mapping Look-Up Table (LUT) based on metadata and display parameters. The metadata are extracted from the identified HDR/WCG video content, and the display parameters of the client device are retrieved from a display panel information database accessible to the cloud-based server. The method also includes encoding the mapping LUT based for transmission through a communication link between the cloud-based server and the client device.

### CROSS-REFERENCE TO RELATED APPLICATIONS

This application claims priority to PCT Patent Application No. PCT/CN2025/079730 filed on Feb. 29, 2026, which is incorporated by reference in its entirety.

### TECHNICAL FIELD

This application relates generally to video tone mapping processing, and more specifically but not exclusively, to methods and systems for streaming High Dynamic Range (HDR) and Wide Color Gamut (WCG) video content.

### BACKGROUND

Herein, the term “tone mapping processing” refers to the conversion of HDR/WCG video content to match the display capabilities of specific display devices. In some examples, tone mapping processing involves complex calculations to preserve visual quality while adapting to different display parameters.

### SUMMARY

Disclosed herein are various embodiments of methods and apparatus for streaming HDR/WCG video content. Various examples provide techniques for offloading HDR/WCG tone mapping operations from client devices to servers. In some embodiments, the server generates mapping Look-Up Tables (LUTs) for tone mapping and then transmits the mapping LUTs to the client device along with compressed video content. In some embodiments, the server performs the tone mapping operations by applying the LUTs on the compressed video content and then sends the resulting compressed, mapped video content to the client device. In some examples, the server incorporates LUT compression techniques including storing keyframes at intervals with differential LUT data between video frames, and polynomial approximation using piecewise cubic coefficients.

According to examples of the present disclosure, a method performed by a cloud-based server for streaming HDR/WCG video content comprises receiving from a client device a request identifying HDR/WCG video content to be streamed; generating a mapping Look-Up Table (LUT) based on metadata and display parameters, wherein the metadata are extracted from the identified HDR/WCG video content, and the display parameters of the client device are retrieved from a display panel information database accessible to the cloud-based server; and encoding the mapping LUT based for transmission through a communication link between the cloud-based server and the client device.

According to examples of the present disclosure, a method performed by a client device for streaming HDR/WCG video content comprises sending through a communication link to a cloud-based server a request identifying HDR/WCG video content to be streamed; receiving encoded data from the cloud-based server, wherein the encoded data are generated based on metadata extracted from the HDR/WCG video content and further based on display parameters of the client device; generating a mapped HDR/WCG video frame based on the encoded data; and displaying the mapped HDR/WCG video frame on a display panel of the client device.

According to examples of the present disclosure, a non-transitory computer-readable medium stores instructions that, when executed by an electronic processor, cause the corresponding apparatus to perform operations comprising any one of the above methods.

According to examples of the present disclosure, an apparatus for streaming HDR/WCG video content comprises: at least one processor; and at least one memory including program code, wherein the at least one memory and the program code are configured to, with the at least one processor, cause the apparatus at least to: receive from a client device a request identifying HDR/WCG video content to be streamed; generate a mapping Look-Up Table (LUT) based on metadata and display parameters, wherein the metadata are extracted from the identified HDR/WCG video content, and the display parameters of the client device are retrieved from a display panel information database accessible to the apparatus; and encode the mapping LUT for transmission through a communication link between the apparatus and the client device.

According to examples of the present disclosure, an apparatus for streaming HDR/WCG video content comprises: at least one processor; and at least one memory including program code, wherein the at least one memory and the program code are configured to, with the at least one processor, cause the apparatus at least to send through a communication link to a cloud-based server a request identifying HDR/WCG video content to be streamed; receive encoded data from the cloud-based server, wherein the encoded data are generated based on metadata extracted from the HDR/WCG video content and further based on display parameters of a client device; generate a mapped HDR/WCG video frame based on the encoded data; and display the mapped HDR/WCG video frame on a display panel of the client device.

### DESCRIPTION OF THE DRAWINGS

Other aspects, features, and benefits of various disclosed embodiments will become more fully apparent, by way of example, from the following detailed description and the accompanying drawings, in which:

FIG. 1 illustrates an HDR/WCG processing system according to some examples.

FIG. 2 illustrates an HDR/WCG processing system according to some additional examples.

FIG. 3 illustrates an HDR/WCG processing system according to some additional examples.

FIG. 4 is a flowchart illustrating a method performed by a cloud-based server for streaming HDR/WCG video content according to some examples.

FIG. 5 is a flowchart illustrating a method performed by a client device for streaming HDR/WCG video content according to some examples.

FIG. 6 is a block diagram of a computing device that can be used in the conjunction with the examples illustrated in FIGS. 1-5.

### DETAILED DESCRIPTION

As used herein, the term "HDR/WCG video content", relates High Dynamic Range (HDR) and Wide Color Gamut (WCG) video that contains enhanced brightness, contrast, and color range compared to standard dynamic range video content, including metadata that define parameters such as Mastering Display Color Volume, Maximum Content Light Level, and Maximum Frame Average Light Level.

As used herein, the term "cloud-based server" relates to a remote computing system that provides processing and storage resources accessible through network connections, capable of performing video processing tasks and maintaining databases of display device parameters, etc.

As used herein, the term "client device" relates to an end-user device that receives and displays video content, including but not limited to mobile devices, head-mounted displays, extended reality glasses, and smartphones.

As used herein, the term "fragment/slicing logic" relates to processing components that segment video content into manageable portions for transmission, including dividing video streams into individual frames or groups of frames.

As used herein, the term "sending logic" relates to components that manage the transmission of video content and associated data between the cloud-based server and client devices, including handling different transmission channels for various types of data.

As used herein, the term "Look-Up Table (LUT)" relates to a pre-calculated array of color transformation values that maps input color values to output color values, enabling efficient conversion between different color spaces and dynamic ranges without performing complex calculations in real-time.

As used herein, the term "LUTs applying" relates to the process of using Look-Up Tables to transform video frame color values according to pre-calculated mapping instructions, enabling efficient color space and dynamic range conversion for specific display parameters.

Conventional HDR/WCG video processing techniques may face technical challenges in client device implementations. Processing HDR/WCG content on client devices typically creates a high demand for computational resources as each video frame demands complex color space transformations and dynamic range adjustments. The generation of mapping LUTs involves intensive calculations based on both the video content metadata and specific display parameters. For mobile devices with limited processing capabilities and battery life constraints, performing these calculations locally may create performance bottlenecks and power consumption issues. Additionally, maintaining device-specific display parameters and coordinating real-time mapping updates between different display types presents significant data management challenges. These technical difficulties impact portable and power-sensitive devices, such as head-mounted displays, extended reality glasses, and low-end smartphones, where processing capabilities and power efficiency are significant constraints.

The disclosed methods and systems provide technical solutions that overcome at least some the above-indicated computational and power consumption challenges of conventional HDR/WCG video processing. By implementing a cloud-based processing architecture with a centralized display parameter database, embodiments of the present disclosure efficiently manage display parameters for diverse client devices while reducing client-side computational demands. The implementation of LUT compression techniques, including keyframe-based differences and polynomial coefficient representations, tends to improve data transmission between the server and client. By transmitting compressed mapping LUTs with video content or performing complete HDR/WCG processing on the server, embodiments of the present disclosure provide flexible solutions adaptable to different network conditions and different levels of client device capabilities. Some technical improvements disclosed herein provide for efficient HDR/WCG video processing on resource-constrained mobile devices while maintaining high-quality video playback, addressing the power consumption and processing bottlenecks in conventional approaches.

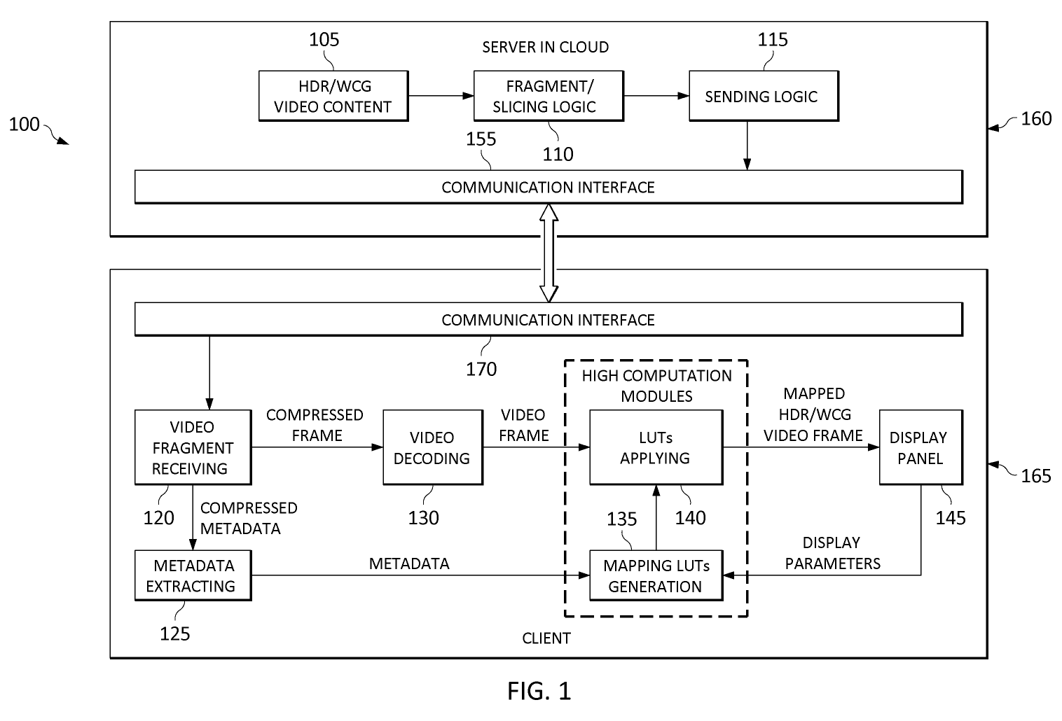

FIG. 1 is a block diagram illustrating an HDR/WCG processing system 100 according to some examples. The HDR/WCG processing system 100 processes an HDR/WCG video content 105 on a client device 165 using metadata and display parameters received from a cloud-based server 160. In some examples, the HDR/WCG processing system 100 employs significant computational resources at the client device 165 for generating and applying the mapping LUTs.

In the example shown, the cloud-based server 160 processes and delivers the HDR/WCG video content 105 to the client device 165. The cloud-based server 160 has the HDR/WCG video content 105 stored in a nonvolatile memory and also includes a fragment/slicing logic 110 and a sending logic 115. The HDR/WCG video content 105 includes video content with high dynamic range and wide color gamut characteristics. For example, the HDR/WCG video content 105 includes content with enhanced brightness, contrast, and color range compared to standard dynamic range video content.

The fragment/slicing logic 110 segments the HDR/WCG video content 105 into compressed frames for transmission. In some examples, the fragment/slicing logic 110 performs video segmentation without considering display-specific parameters or HDR/WCG processing specifications of the client device 165, as these parameters are processed in the HDR/WCG processing system 100 on the client side.

The sending logic 115 transmits the compressed frames, via a communication interface 155, to the client device 165. In some examples, the sending logic 115 treats the HDR/WCG video content transmission similarly to standard video content transmission, leaving HDR/WCG-specific processing tasks to the client device 165. In some examples, the client device 165 may not have sufficient processing capabilities to handle complex HDR/WCG computations. In these examples, the HDR/WCG processing at the client device 165 may be significantly and disadvantageously impaired.

The client device 165 includes a communication interface 170, a video fragment receiving module 120, a metadata extracting module 125, a video decoding module 130, a mapping LUTs generation module 135, a LUTs applying module 140, and a display panel 145. The client device 165 processes and displays the received HDR/WCG video content.

The video fragment receiving module 120 receives the compressed frames from the cloud-based server 160. In some examples, the video fragment receiving module 120 receives the compressed frames through the communication interface 170 at a bandwidth that varies based on the network conditions.

The metadata extracting module 125 extracts metadata from the compressed metadata received from the cloud-based server 160. In some examples, the metadata include Mastering Display Color Volume, Maximum Content Light Level (MaxCLL), and Maximum Frame Average Light Level (MaxFALL). Mastering Display Color Volume defines the color space and brightness range of the display used to create the HDR/WCG content. Maximum Content Light Level (MaxCLL) represents the brightest pixel value in the entire HDR/WCG video content. Maximum Frame Average Light Level (MaxFALL) indicates the average brightness level across frames in the HDR/WCG video content. The metadata may be used to calculate optimal tone mapping and color gamut adjustments for the display panel 145.

The video decoding module 130 decodes the compressed frames to generate video frames. In some examples, the video decoding module 130 converts the compressed frames back to original frame format by applying inverse compression operations to restore the full visual information of each frame.

The mapping LUTs generation module 135 generates mapping LUTs based on the extracted metadata and display parameters. In some examples, the mapping LUTs translate HDR/WCG color values to values based on the display panel characteristics. The mapping LUTs generation module 135 employs significant computational resources at the client device 165, as the generation of mapping LUTs involves relatively complex calculations for each frame.

The LUTs applying module 140 applies the mapping LUTs to the video frames to generate mapped HDR/WCG video frames. For example, the LUTs applying module 140 transforms each pixel value according to the mapping defined in the mapping LUTs. The LUTs applying module 140 represents another computationally intensive process that employs substantial processing power at the client device 165.

The display panel 145 displays the mapped HDR/WCG video frames. The display panel 145 has specific display characteristics, such as color primaries, white point, peak luminance, and color gamut capabilities.

In the example illustrated in FIG. 1, the client device 165 performs both the generation and application of mapping LUTs, thereby creating high computational loads. For devices with limited processing capabilities and battery life, such as mobile devices, the computationally intensive operations present challenges for implementing HDR/WCG video processing. The high computational loads may particularly adversely impact portable and power-sensitive devices, such as head-mounted displays, extended reality (XR) glasses, and low-end smartphones. Herein, the term “XR glasses” refers to wearable display devices that support virtual reality (VR), augmented reality (AR), or mixed reality (MR) applications.

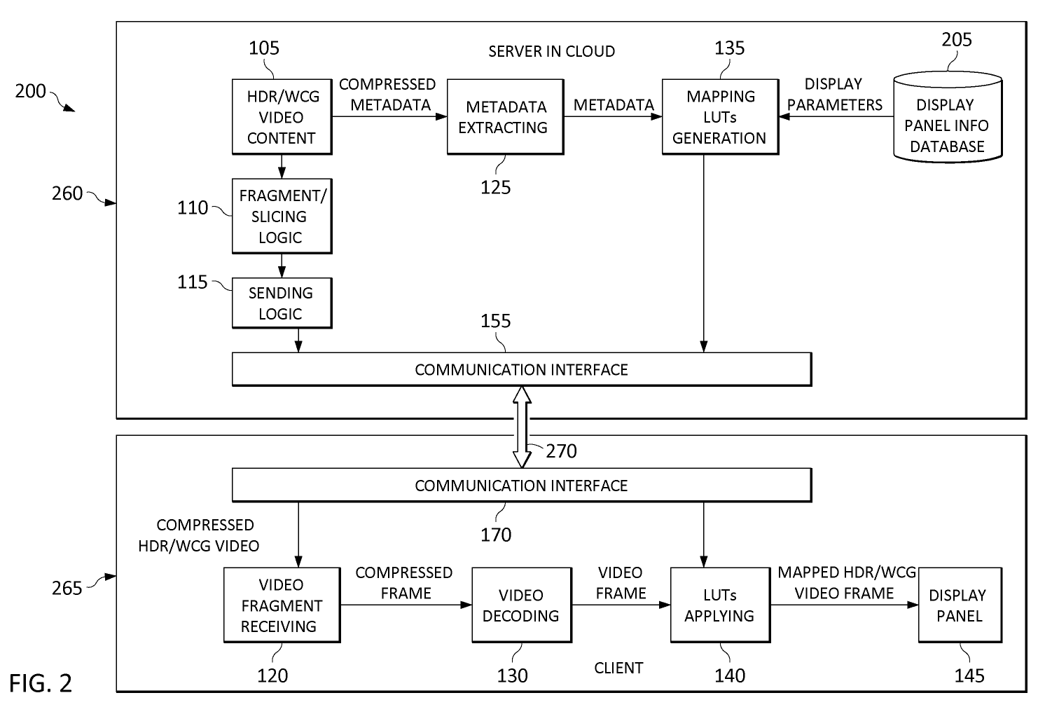

FIG. 2 illustrates an HDR/WCG processing system 200 according to some additional examples. The HDR/WCG processing system 200, in contrast to some examples of the HDR/WCG processing system 100, has the mapping LUTs generation module 135 moved from a client device 265 to a cloud-based server 260. The HDR/WCG processing system 200 reduces processing loads at the client device 265 while maintaining efficient delivery of the HDR/WCG video content 105.

In the system 200, the cloud-based server 260 offloads HDR/WCG processing from the client device 265. The cloud-based server 260 includes the metadata extracting module 125, the mapping LUTs generation module 135, and a display panel information database 205. The client device 265 includes the video fragment receiving module 120, the video decoding module 130, the LUTs applying module 140, and the display panel 145.

With reference to FIG. 2, the metadata extracting module 125 in the cloud-based server 260 extracts metadata from the HDR/WCG video content 105. The mapping LUTs generation module 135 generates mapping LUTs based on the extracted metadata and the display parameters retrieved from the display panel information database 205.

The display panel information database 205 stores display parameters. In some examples, the display parameters include the manufacturer identifier, model identifier, resolution (e.g., 1920x1080, 2560x1440), refresh rate (e.g., 60Hz, 120Hz, 144Hz), color primaries, white point, color gamut, peak luminance, black level, and contrast ratio. In some examples, the display panel information database 205 implements a relational database structure to enable fast retrieval and minimize storage overhead.

The implementation of the display panel information database 205 addresses some of the technical challenges in server-side HDR/WCG processing. As discussed above, managing the display parameters for diverse client devices in a centralized database presents challenges in terms of data organization and retrieval efficiency, as the database needs to handle varying parameter formats across different device manufacturers and models. The relational database structure organizes these parameters to provide efficient querying based on the device identifiers while maintaining relationships between related display characteristics.

In some examples, the mapping LUTs are generated with the module 135 based on device-specific parameters (e.g., color primaries, white point, and peak luminance) which are stored at the cloud-based server 260 and are dynamically updated for scenes with variable metadata.

The mapping LUTs generation module 135 compresses the generated mapping LUTs based on the transmission bandwidth between the cloud-based server 260 and the client device 265.

In some examples, the compression stores a full mapping LUT at keyframe intervals and generates differences between consecutive mapping LUTs for frames between the keyframes. The mapping LUTs generation module 135 may store a full LUT as a keyframe at regular intervals, e.g., frame by frame or every few seconds. For in-between frames, LUT differences, e.g., the delta values, are stored. The mapping LUTs generation module 135 then applies lossless compression techniques to compress these delta values. Example lossless compression techniques include, but are not limited to, Huffman encoding, run-length encoding. When the scene changes in the video frames are gradual, the transmission bandwidth allocation between the cloud-based server 260 and the client device 265 may be reduced.

In some additional examples, the compression represents mapping LUT transformations using piecewise cubic polynomial coefficients for smooth tone curves and gamma corrections. The mapping LUTs generation module 135 compresses the LUTs by predicting values using mathematical models, such as using piecewise cubic polynomials to model color transformations. Polynomial approximation can be used to represent LUT transformations using polynomial equations. In these examples, the piecewise cubic polynomial coefficients instead of the mapping LUTs are stored.

In some examples, the display panel information database 205 works with LUT compression techniques to optimize server-side processing. By maintaining precise display parameters, the display panel information database 205 enables generation of accurate mapping LUTs that can be effectively compressed using keyframe intervals or polynomial coefficients. This combination of centralized parameter management and efficient LUT compression makes server-side HDR/WCG processing practical despite the challenges of handling diverse display specifications and managing transmission bandwidth.

The fragment/slicing logic 110 segments the HDR/WCG video content 105 into compressed frames. In some examples, the sending logic 115 transmits these compressed frames through the communication interface 155 and transmits the compressed mapping LUTs through the LUTs info channel of a communication link 270 to the client device 265.

The communication link 270 may be a communication medium that enables data exchange between devices, including wired, fiberoptic, and wireless communication links. Example technologies used to implement the communication link 270 may include, but are not limited to, wireless technologies, such as Wi-Fi, Bluetooth, cellular networks (e.g., 4G, 5G), and satellite communication; wired connections, such as Ethernet, fiberoptic links, and power line communication (PLC); as well as Internet-based links utilizing TCP/IP protocols. The communication link 270 may also include local and wide-area networks (LAN, WAN) and hybrid communication systems that combine multiple technologies to optimize connectivity, bandwidth, and reliability based on operational requirements.

The sending logic 115 transmits these compressed frames through a communication interface 155 to the client device 265. The sending logic 115 transmits the compressed mapping LUTs through a dedicated LUTs information channel of the communication link 270 to the client device 265. The LUTs information channel carries compressed LUTs information and corresponding timing information from the cloud-based server 260 to the client device 265. In some examples, the client device 265 sends LUTs requests to the cloud-based server 260 through the LUTs info channel of the communication link 270 for initial playback, random playback, or error handling cases.

At the client device 265, the video fragment receiving module 120 first sends a request for HDR/WCG video content to the cloud-based server 260. The request includes device identification information that enables the cloud-based server 260 to retrieve the corresponding display parameters from the display panel information database 205.

The video fragment receiving module 120 receives the compressed frames through the communication interface 170. The video decoding module 130 processes the compressed frames to generate video frames. The LUTs applying module 140 receives mapping LUTs through a LUTs information channel of the communication link 270. In some examples, when the compressed LUTs include LUT differences, the LUTs applying module 140 receives a full mapping LUT at keyframe intervals and LUT differences for frames between the keyframes. The LUTs applying module 140 applies the mapping LUTs to the video frames to generate mapped HDR/WCG video frames for the display panel 145. When LUT differences are received, the LUTs applying module 140 reconstructs subsequent mapping LUTs based on the received full mapping LUT and the LUT differences before applying the reconstructed mapping LUTs to the video frames.

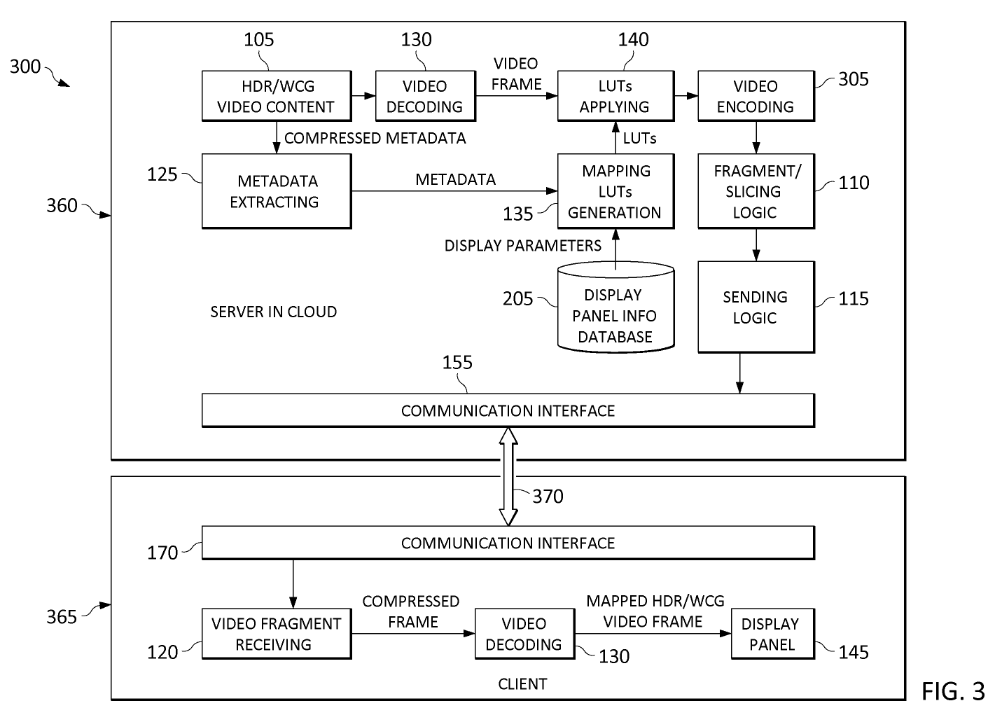

FIG. 3 illustrates an HDR/WCG processing system 300 according to some additional examples. The HDR/WCG processing system 300 performs the HDR/WCG processing on the server side before transmission to the client device. The system 300 significantly reduces the processing loads for a client device 365 through server-side video frame mapping.

In the system 300, a cloud-based server 360 includes the HDR/WCG video content 105, the metadata extracting module 125, the video decoding module 130, the mapping LUTs generation module 135, the LUTs applying module 140, a video encoding module 305, the fragment/slicing logic 110, the sending logic 115, and the display panel information database 205. The cloud-based server 360 is communicatively connected to the client device 365 via a communication link 370. In various examples, the communication link 370 may be analogous to the above-described communication link 270 (FIG. 2).

The LUTs applying module 140 and the video encoding module 305 are implemented in the cloud-based server 360, and the cloud-based server 360 performs HDR/WCG processing before transmission of video data to the client device 365.

In some examples, the cloud-based server 360 performs full tone mapping on the video frames using pre-calculated LUTs. In some additional examples, the cloud-based server 360 performs full tone mapping on the video frames using real-time algorithms. As used herein, the term “real time” refers to a computer-based process that controls a corresponding environment by receiving data, processing the received data, and generating a response sufficiently quickly to affect the environment without significant delay. Real-time responses are often understood to be on the order of milliseconds, or sometimes microseconds.

The client device 365 includes the video fragment receiving module 120, the video decoding module 130, and the display panel 145. With reference to FIG. 3, after receiving a request from the client device 365, the video decoding module 130 in the cloud-based server 360 decodes the HDR/WCG video content 105 to obtain video frames. The metadata extracting module 125 extracts metadata from the HDR/WCG video content 105. The mapping LUTs generation module 135 generates mapping LUTs based on the extracted metadata and display parameters retrieved from the display panel information database 205.

The LUTs applying module 140 in the cloud-based server 360 applies the mapping LUTs to the video frames to generate mapped HDR/WCG video frames. The video encoding module 305 encodes these mapped HDR/WCG video frames before transmission.

The video fragment receiving module 120 in the client device 365 receives the encoded mapped HDR/WCG video frames. The video decoding module 130 decodes the encoded mapped HDR/WCG video frames for display on the display panel 145.

### Example Workflows

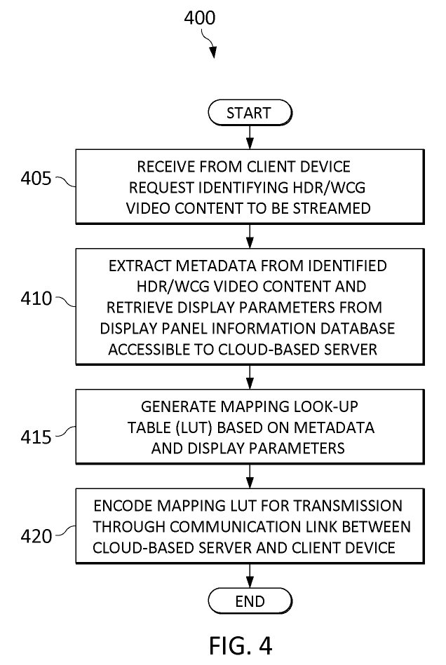

FIG. 4 is a flowchart illustrating a method 400 performed by a cloud-based server (e.g., 260, 360) for streaming HDR/WCG video content (e.g., 105). The method 400 may be performed by the cloud-based servers 260, 360 in the HDR/WCG processing systems 200 and 300.

Operations of block 405 include receiving from a client device a request identifying the HDR/WCG video content to be streamed. The request includes device identification information for the client device, enabling the cloud-based server to retrieve corresponding display parameters.

Operations of block 410 include extracting metadata from the identified HDR/WCG video content and retrieving display parameters from a display panel information database maintained by the cloud-based server. In some examples, the metadata comprise at least one of: a Mastering Display Color Volume, a Maximum Content Light Level (MaxCLL), or a Maximum Frame Average Light Level (MaxFALL).

Operations of block 415 include generating a mapping Look-Up Table (LUT) based on the metadata and the display parameters. In some examples, the metadata are extracted from the identified HDR/WCG video content, and the display parameters of the client device are retrieved from a display panel information database accessible to the cloud-based server. In some examples, the method further includes decoding the HDR/WCG video content to obtain a video frame, generating a mapped video frame by applying the mapping LUT to the video frame, encoding the mapped video frame, and transmitting the encoded mapped video frame to the client device.

Operations of block 420 include encoding the mapping LUT based for transmission through a communication link between the cloud-based server and the client device. In some examples, encoding the mapping LUT comprises storing the mapping LUT as a keyframe at a predetermined interval, and generating a difference between the mapping LUT stored as the keyframe and each subsequent mapping LUT within the predetermined interval. In some examples, encoding the mapping LUT comprises representing a transformation of the mapping LUT using a piecewise cubic polynomial coefficient, wherein representing the transformation of the mapping LUT comprises storing the piecewise cubic polynomial coefficient for the mapping LUT and representing the transformation using the piecewise cubic polynomial coefficient to generate tone mapping values for the HDR/WCG video content.

In some examples, the method 400 further includes transmitting the identified HDR/WCG video content through the communication link to the client device and, transmitting the encoded mapping LUT through a LUT channel of the communication link to the client device in response to the request.

In some alternative examples, the method 400 further includes decoding the HDR/WCG video content to obtain a video frame, generating a mapped video frame by applying the mapping LUT to the video frame, encoding the mapped video frame, and transmitting the encoded mapped video frame through the communication link to the client device in response to the request. In these examples, the HDR/WCG processing is completed on the cloud-based server before transmission.

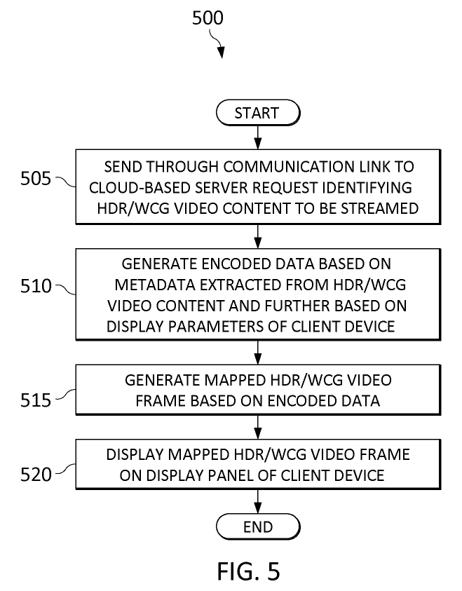

FIG. 5 is a flowchart illustrating a method 500 performed by a client device server (e.g., 260, 360) for streaming HDR/WCG video content (e.g., 105) according to some examples. The method 500 may be performed by the client device in the HDR/WCG processing systems 200 and 300. The client device may include one or more of the computing device 600 configured to execute the operations described below.

Operations of a block 505 include sending through a communication link to a cloud-based server a request identifying HDR/WCG video content to be streamed. The request includes device identification information for the client device, enabling the cloud-based server to access the display parameters of the client device for HDR/WCG video processing.

Operations of a block 510 include receiving encoded data from the cloud-based server, wherein the encoded data are generated based on metadata extracted from the HDR/WCG video content and further based on display parameters of the client device. In some examples, the display parameters comprise at least one of: a manufacturer identifier, a model identifier, a resolution, a refresh rate, a color primary, a white point, a peak luminance, or a contrast ratio of the client device.

Operations of a block 515 include generating a mapped HDR/WCG video frame based on the encoded data. In some examples, the encoded data comprises an encoded mapped HDR/WCG video frame, and generating the mapped HDR/WCG video frame comprises decoding the encoded mapped HDR/WCG video frame. In some alternative examples, generating the mapped HDR/WCG video frame comprises generating a video frame by decoding the encoded data to obtain the video frame and a mapping Look-Up Table (LUT), and generating the mapped HDR/WCG video frame by applying the mapping LUT to the video frame.

In some examples, the encoded data further comprises a difference between the mapping LUT and a subsequent mapping LUT within a predetermined interval, and generating the mapped HDR/WCG video frame comprises applying the subsequent mapping LUT reconstructed based on the difference.

Operations of a block 520 include displaying the mapped HDR/WCG video frame on a display panel of the client device. For example, the display panel receives the mapped HDR/WCG video frame processed according to the specific display parameters of the client device. The mapped HDR/WCG video provides improved HDR/WCG content rendering in response to the display characteristics.

In some examples, the method 500 further includes detecting a transmission error in the encoded data and sending a request to the cloud-based server for retransmission of the encoded data. For example, when a transmission error is detected during the reception of the encoded mapped HDR/WCG video frame or the mapping LUT data, the client device sends a retransmission request through the communication interface to the cloud-based server to maintain playback quality.

### Example Hardware

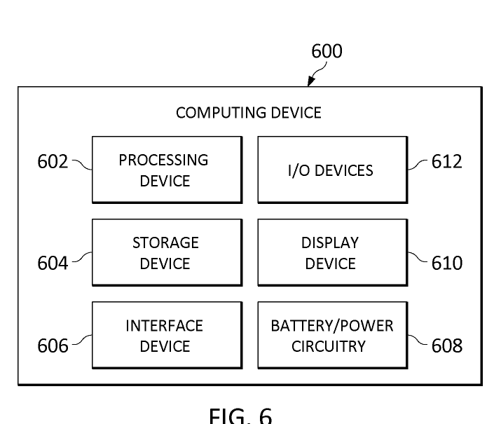

FIG. 6 is a block diagram of a computing device that can be used in the conjunction with the examples illustrated in FIGS. 1-5. The computing device 600 is an apparatus configured to perform at least some operations of the above-described methods, algorithms, and procedures according to some examples. The computing device 600 includes at least one processor and at least one memory including program code, wherein the at least one memory and the program code are configured to, with the at least one processor, cause the apparatus to perform at least some operations of the method 400 the method 500 for video content processing.

The computing device 600 of FIG. 6 is illustrated as having a number of components, but any one or more of these components may be omitted or duplicated, as suitable for the application and setting. In some embodiments, some or all of the components included in the computing device 600 may be attached to one or more motherboards and enclosed in a housing. In some embodiments, some of those components may be fabricated onto a single system-on-a-chip (SoC) (e.g., the SoC may include one or more processing devices 602 and one or more storage devices 604). Additionally, in various embodiments, the computing device 600 may not include one or more of the components illustrated in FIG. 6, but may include interface circuitry for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 600 may not include a display device 610, but may include display device interface circuitry (e.g., a connector and driver circuitry) to which an external display device 610 may be coupled.

The computing device 600 includes a processing device 602 (e.g., one or more processing devices). As used herein, the term “processing device” refers to any device or portion of a device that processes electronic data from registers and/or memory to transform that electronic data into other electronic data that may be stored in registers and/or memory. In various embodiments, the processing device 602 may include one or more digital signal processors (DSPs), application-specific integrated circuits (ASICs), central processing units (CPUs), graphics processing units (GPUs), server processors, or any other suitable processing devices.

The computing device 600 also includes a storage device 604 (e.g., one or more storage devices). In various embodiments, the storage device 604 may include one or more memory devices, such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 604 may include memory that shares a die with the processing device 602. In such an embodiment, the memory may be used as cache memory and include embedded dynamic random-access memory (eDRAM) or spin transfer torque magnetic random-access memory (STT-MRAM), for example. In some embodiments, the storage device 604 may include non-transitory computer readable media having instructions thereon that, when executed by one or more processing devices (e.g., the processing device 602), cause the computing device 600 to perform any appropriate ones of the methods disclosed herein or portions of such methods.

The computing device 600 further includes an interface device 606 (e.g., one or more interface devices 606). In various embodiments, the interface device 606 may include one or more communication chips, connectors, and/or other hardware and software to govern communications between the computing device 600 and other computing devices. For example, the interface device 606 may include circuitry for managing wireless communications for the transfer of data to and from the computing device 600. The term “wireless” and its derivatives may be used to describe circuits, devices, systems, methods, techniques, communications channels, etc., that may communicate data via modulated electromagnetic radiation through a nonsolid medium. The term does not imply that the associated devices do not contain any wires, although in some embodiments they might not. Circuitry included in the interface device 606 for managing wireless communications may implement any of a number of wireless standards or protocols, including but not limited to Institute for Electrical and Electronic Engineers (IEEE) standards including Wi-Fi (IEEE 802.11 family), IEEE 802.16 standards, Long-Term Evolution (LTE) project along with any amendments, updates, and/or revisions (e.g., advanced LTE project, ultramobile broadband (UMB) project (also referred to as "3GPP2"), etc.). In some embodiments, circuitry included in the interface device 606 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 606 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 606 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 606 may include one or more antennas (e.g., one or more antenna arrays) configured to receive and/or transmit wireless signals.

In some embodiments, the interface device 606 may include circuitry for managing wired communications, such as electrical, optical, or any other suitable communication protocols. For example, the interface device 606 may include circuitry to support communications in accordance with Ethernet technologies. In some embodiments, the interface device (806) may support both wireless and wired communication, and/or may support multiple wired communication protocols and/or multiple wireless communication protocols. For example, a first set of circuitry of the interface device 606 may be dedicated to shorter-range wireless communications such as Wi-Fi or Bluetooth, and a second set of circuitry of the interface device 606 may be dedicated to longer-range wireless communications such as global positioning system (GPS), EDGE, GPRS, CDMA, WiMAX, LTE, EV-DO, or others. In some other embodiments, a first set of circuitry of the interface device 606 may be dedicated to wireless communications, and a second set of circuitry of the interface device 606 may be dedicated to wired communications.

The computing device 600 also includes battery/power circuitry 608. In various embodiments, the battery/power circuitry 608 may include one or more energy storage devices (e.g., batteries or capacitors) and/or circuitry for coupling components of the computing device 600 to an energy source separate from the computing device 600 (e.g., to AC line power).

The computing device 600 also includes a display device 610 (e.g., one or multiple individual display devices). In various embodiments, the display device 610 may include any visual indicators, such as a heads-up display, a computer monitor, a projector, a touchscreen display, a liquid crystal display (LCD), a light-emitting diode display, or a flat panel display.

The computing device 600 also includes additional input/output (I/O) devices 612. In various embodiments, the I/O devices 612 may include one or more data/signal transfer interfaces, audio I/O devices (e.g., microphones or microphone arrays, speakers, headsets, earbuds, alarms, etc.), audio codecs, video codecs, printers, sensors (e.g., thermocouples or other temperature sensors, humidity sensors, pressure sensors, vibration sensors, etc.), image capture devices (e.g., one or more cameras), human interface devices (e.g., keyboards, cursor control devices, such as a mouse, a stylus, a trackball, or a touchpad), etc.

Depending on the specific embodiment, various components of the interface devices 606 and/or I/O devices 612 can be configured to output suitable signals, receive suitable signals, and receive and output data streams. In some examples, the interface devices 606 and/or I/O devices 612 include one or more analog-to-digital converters (ADCs) for transforming received analog signals into a digital form suitable for operations performed by the processing device 602 and/or the storage device 604. In some additional examples, the interface devices 606 and/or I/O devices 612 include one or more digital-to-analog converters (DACs) for transforming digital signals provided by the processing device 602 and/or the storage device 604 into an analog form suitable for being communicated over the corresponding communication channels.

EEE1. A method performed by a cloud-based server for streaming HDR/WCG video content comprises receiving from a client device a request identifying HDR/WCG video content to be streamed; generating a mapping Look-Up Table (LUT) based on metadata and display parameters, wherein the metadata are extracted from the identified HDR/WCG video content, and the display parameters of the client device are retrieved from a display panel information database accessible to the cloud-based server; and encoding the mapping LUT for transmission through a communication link between the cloud-based server and the client device.

EEE2. The method according to EEE1, further comprises transmitting the identified HDR/WCG video content through the communication link to the client device and transmitting the encoded mapping LUT through a LUT channel of the communication link to the client device in response to the request.

EEE3. The method according to any of EEE1 to EEE2, further comprises decoding the HDR/WCG video content to obtain a video frame; generating a mapped video frame by applying the mapping LUT to the video frame; encoding the mapped video frame; and transmitting the encoded mapped video frame through the communication link to the client device in response to the request.

EEE4. The method according to any of EEE1 to EEE3, wherein encoding the mapping LUT comprises storing the mapping LUT as a keyframe at a predetermined interval, and generating a difference between the mapping LUT stored as the keyframe and each subsequent mapping LUT within the predetermined interval.

EEE5. The method according to any of EEE1 to EEE4, wherein encoding the mapping LUT comprises representing a transformation of the mapping LUT using a piecewise cubic polynomial coefficient.

EEE6. The method according to EEE5, wherein representing the transformation of the mapping LUT comprises storing the piecewise cubic polynomial coefficient for the mapping LUT; and representing the transformation using the piecewise cubic polynomial coefficient to generate tone mapping values for the HDR/WCG video content.

EEE7. The method according to any of EEE1 to EEE6, wherein the metadata comprise at least one of: a Mastering Display Color Volume, a Maximum Content Light Level (MaxCLL), or a Maximum Frame Average Light Level (MaxFALL).

EEE8. A non-transitory computer-readable medium storing instructions that, when executed by an electronic processor, cause the electronic processor to perform operations comprising any one of the methods of EEE1 to EEE7.

EEE9. A method performed by a client device for streaming HDR/WCG video content comprises sending through a communication link to a cloud-based server a request identifying HDR/WCG video content to be streamed; receiving encoded data from the cloud-based server, wherein the encoded data are generated based on metadata extracted from the HDR/WCG video content and further based on display parameters of the client device; generating a mapped HDR/WCG video frame based on the encoded data; and displaying the mapped HDR/WCG video frame on a display panel of the client device.

EEE10. The method according to EEE9, wherein the encoded data comprise an encoded mapped HDR/WCG video frame, and wherein generating the mapped HDR/WCG video frame comprises decoding the encoded mapped HDR/WCG video frame.

EEE11. The method according to any of EEE9 to EEE10, wherein generating the mapped HDR/WCG video frame comprises generating a video frame by decoding the encoded data to obtain the video frame and a mapping Look-Up Table (LUT); and generating the mapped HDR/WCG video frame by applying the mapping LUT to the video frame.

EEE12. The method according to any of EEE9 to EEE11, wherein the encoded data further comprise a difference between the mapping LUT and a subsequent mapping LUT within a predetermined interval; and generating the mapped HDR/WCG video frame comprises applying the subsequent mapping LUT reconstructed based on the difference.

EEE13. The method according to any of EEE9 to EEE12, wherein the display parameters comprise at least one of: a manufacturer identifier, a model identifier, a resolution, a refresh rate, a color primary, a white point, a peak luminance, or a contrast ratio of the client device.

EEE14. The method according to any of EEE9 to EEE13, further comprises detecting a transmission error in the encoded data; and sending a request to the cloud-based server for retransmission of the encoded data.

EEE15. The method according to any of EEE9 to EEE14, wherein the client device is selected from the group consisting of a mobile device, a head-mounted display (HMD), an extended reality (XR) glasses, and a smartphone.

EEE16. A non-transitory computer-readable medium storing instructions that, when executed by an electronic processor, cause the electronic processor to perform operations comprising any one of the methods of EEE9 to EEE15.

EEE17. An apparatus for streaming HDR/WCG video content comprises at least one processor; and at least one memory including program code, wherein the at least one memory and the program code are configured to, with the at least one processor, cause the apparatus at least to receive from a client device a request identifying HDR/WCG video content to be streamed; generate a mapping Look-Up Table (LUT) based on metadata and display parameters, wherein the metadata are extracted from the identified HDR/WCG video content, and the display parameters of the client device are retrieved from a display panel information database accessible to the apparatus; and encode the mapping LUT for transmission through a communication link between the apparatus and the client device.

EEE18. The apparatus according to EEE17, wherein the at least one memory and the program code are configured to, with the at least one processor, further cause the apparatus to transmit the identified HDR/WCG video content through the communication link to the client device; and transmit the encoded mapping LUT through a LUT channel of the communication link to the client device in response to the request.

EEE19. The apparatus according to any of EEE17 to EEE18, wherein the at least one memory and the program code are configured to, with the at least one processor, further cause the apparatus to decode the HDR/WCG video content to obtain a video frame; generate a mapped video frame by applying the mapping LUT to the video frame; encode the mapped video frame; and transmit the encoded mapped video frame through the communication link to the client device in response to the request.

EEE20. The apparatus according to any of EEE17 to EEE19, wherein encoding the mapping LUT comprises storing the mapping LUT as a keyframe at a predetermined interval, and generating a difference between the mapping LUT stored as the keyframe and each subsequent mapping LUT within the predetermined interval.

EEE21. The apparatus according to any of EEE17 to EEE20, wherein encoding the mapping LUT comprises representing a transformation of the mapping LUT using a piecewise cubic polynomial coefficient.

EEE22. The apparatus according to any of EEE17 to EEE21, wherein representing the transformation of the mapping LUT comprises storing the piecewise cubic polynomial coefficient for the mapping LUT; and representing the transformation using the piecewise cubic polynomial coefficient to generate tone mapping values for the HDR/WCG video content.

EEE23. The apparatus according to any of EEE17 to EEE22, wherein the metadata comprise at least one of: a Mastering Display Color Volume, a Maximum Content Light Level (MaxCLL), or a Maximum Frame Average Light Level (MaxFALL).

EEE24. An apparatus for streaming HDR/WCG video content corresponding comprises at least one processor; and at least one memory including program code, wherein the at least one memory and the program code are configured to, with the at least one processor, cause the apparatus at least to: send through a communication link to a cloud-based server a request identifying HDR/WCG video content to be streamed; receive encoded data from the cloud-based server, wherein the encoded data are generated based on metadata extracted from the HDR/WCG video content and further based on display parameters of a client device; generate a mapped HDR/WCG video frame based on the encoded data; and display the mapped HDR/WCG video frame on a display panel of the client device.

A person skilled in the art realizes that the present disclosure by no means is limited to the embodiments described above. On the contrary, many modifications and variations are possible and considered within the scope of the appended claims. Various aspects and implementations of the present disclosure may also be appreciated from the following enumerated example embodiments (EEEs), which are not claims, and which may represent systems, methods, and devices, all arranged in accordance with aspects of the present disclosure.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented disclosure(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented disclosure(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated. Conversely, the terms “directly coupled,” “directly connected,” etc., imply the absence of such additional elements.

As used herein in reference to an element and a standard, the term compatible means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify elements or features of the claimed subject matter, nor is it intended to limit the scope of the claimed subject matter.

1. A method performed by a cloud-based server for streaming HDR/WCG video content, the method comprising:
receiving from a client device a request identifying HDR/WCG video content to be streamed;
generating a mapping Look-Up Table (LUT) based on metadata and display parameters, wherein the metadata are extracted from the identified HDR/WCG video content, and the display parameters of the client device are retrieved from a display panel information database accessible to the cloud-based server; and
encoding the mapping LUT based for transmission through a communication link between the cloud-based server and the client device.

2. The method of claim 1, further comprising:
transmitting the identified HDR/WCG video content through the communication link to the client device and;
transmitting the encoded mapping LUT through a LUT channel of the communication link to the client device in response to the request.

3. The method of claim 1, further comprising:
decoding the HDR/WCG video content to obtain a video frame;
generating a mapped video frame by applying the mapping LUT to the video frame;
encoding the mapped video frame; and
transmitting the encoded mapped video frame through the communication link to the client device in response to the request.

4. The method of claim 1, wherein encoding the mapping LUT comprises:
storing the mapping LUT as a keyframe at a predetermined interval, and
generating a difference between the mapping LUT stored as the keyframe and each subsequent mapping LUT within the predetermined interval.

5. The method of claim 1, wherein encoding the mapping LUT comprises:
representing a transformation of the mapping LUT using a piecewise cubic polynomial coefficient.

6. The method of claim 5, wherein representing the transformation of the mapping LUT comprises:
storing the piecewise cubic polynomial coefficient for the mapping LUT; and
representing the transformation using the piecewise cubic polynomial coefficient to generate tone mapping values for the HDR/WCG video content.

7. A method performed by a client device for streaming HDR/WCG video content, the method comprising:
sending through a communication link to a cloud-based server a request identifying HDR/WCG video content to be streamed;
receiving encoded data from the cloud-based server, wherein the encoded data are generated based on metadata extracted from the HDR/WCG video content and further based on display parameters of the client device;
generating a mapped HDR/WCG video frame based on the encoded data; and
displaying the mapped HDR/WCG video frame on a display panel of the client device.

8. The method of claim 7,
wherein the encoded data comprise an encoded mapped HDR/WCG video frame, and
wherein generating the mapped HDR/WCG video frame comprises decoding the encoded mapped HDR/WCG video frame.

9. The method of claim 7, wherein generating the mapped HDR/WCG video frame comprises:
generating a video frame by decoding the encoded data to obtain the video frame and a mapping Look-Up Table (LUT); and
generating the mapped HDR/WCG video frame by applying the mapping LUT to the video frame.

10. The method of claim 9, wherein:
the encoded data further comprise a difference between the mapping LUT and a subsequent mapping LUT within a predetermined interval; and
generating the mapped HDR/WCG video frame comprises applying the subsequent mapping LUT reconstructed based on the difference.

11. The method of claim 7, wherein the display parameters comprise at least one of: a manufacturer identifier, a model identifier, a resolution, a refresh rate, a color primary, a white point, a peak luminance, or a contrast ratio of the client device.

12. The method of claim 7, further comprising:
detecting a transmission error in the encoded data; and
sending a request to the cloud-based server for retransmission of the encoded data.

13. The method of claim 7, wherein the client device is selected from the group consisting of: a mobile device, a head-mounted display (HMD), extended reality (XR) glasses, and a smartphone.

14. An apparatus for streaming HDR/WCG video content, the apparatus comprising:
at least one processor; and
at least one memory including program code, wherein the at least one memory and the program code are configured to, with the at least one processor, cause the apparatus at least to:
receive from a client device a request identifying HDR/WCG video content to be streamed;
generate a mapping Look-Up Table (LUT) based on metadata and display parameters, wherein the metadata are extracted from the identified HDR/WCG video content, and the display parameters of the client device are retrieved from a display panel information database accessible to the apparatus; and
encode the mapping LUT for transmission through a communication link between the apparatus and the client device.

15. The apparatus of claim 14, wherein the at least one memory and the program code are configured to, with the at least one processor, further cause the apparatus to:
transmit the identified HDR/WCG video content through the communication link to the client device; and
transmit the encoded mapping LUT through a LUT channel of the communication link to the client device in response to the request.

16. The apparatus of claim 14, wherein the at least one memory and the program code are configured to, with the at least one processor, further cause the apparatus to:
decode the HDR/WCG video content to obtain a video frame;
generate a mapped video frame by applying the mapping LUT to the video frame;
encode the mapped video frame; and
transmit the encoded mapped video frame through the communication link to the client device in response to the request.

17. The apparatus of claim 14, wherein encoding the mapping LUT comprises:
storing the mapping LUT as a keyframe at a predetermined interval, and
generating a difference between the mapping LUT stored as the keyframe and each subsequent mapping LUT within the predetermined interval.

18. The apparatus of claim 14, wherein encoding the mapping LUT comprises:
representing a transformation of the mapping LUT using a piecewise cubic polynomial coefficient.

19. The apparatus of claim 18, wherein representing the transformation of the mapping LUT comprises:
storing the piecewise cubic polynomial coefficient for the mapping LUT; and
representing the transformation using the piecewise cubic polynomial coefficient to generate tone mapping values for the HDR/WCG video content.

20. An apparatus for streaming HDR/WCG video content, the apparatus comprising:
at least one processor; and
at least one memory including program code, wherein the at least one memory and the program code are configured to, with the at least one processor, cause the apparatus at least to:
send through a communication link to a cloud-based server a request identifying HDR/WCG video content to be streamed;
receive encoded data from the cloud-based server, wherein the encoded data are generated based on metadata extracted from the HDR/WCG video content and further based on display parameters of a client device;
generate a mapped HDR/WCG video frame based on the encoded data; and
display the mapped HDR/WCG video frame on a display panel of the client device.
